(19) United States
(12) Patent Application Publication
(10) Pub. No.: US 2009/0133973 A1
(43) Pub. Date: May 28, 2009

(54) PARKING BRAKE APPARATUS

(76) Inventor: Toshiya Shibata, Nagoya-shi (JP)

Correspondence Address: BUCHANAN, INGERSOLL & ROONEY PC, POST OFFICE BOX 1404, ALEXANDRIA, VA, 22313-1404, US

(21) Appl. No.: 12/275,488

(22) Filed: Nov. 21, 2008

(30) Foreign Application Priority Data
Nov. 28, 2007 (JP) 2007-307413

(51) Int. Cl. F16D 55/02

(52) U.S. Cl. 188/71.3

(57) ABSTRACT

A parking brake apparatus includes a first braking member provided at a wheel and integrally rotated with the wheel, a second braking member provided at a vehicle body side for stopping a rotation of the first braking member, a parking brake device for pressing the second braking member to the first braking member by an operating force of a parking brake operation, a pressurizing device for pressurizing a brace fluid independently of the parking brake operation, and a hydraulic pressure controlling device for preliminarily pressing the second braking member to the first braking member by a brake fluid pressure pressurized by the pressurizing device in a case when the second braking member is pressed to the first braking member by means of the parking brake device.

This application is based on and claims priority under 35 U.S.C. §119 to Japanese Patent Application 2007-307413, filed on Nov. 28, 2007, the entire contents of which is incorporated herein by reference.

### FIELD OF THE INVENTION

The present invention relates to a parking brake apparatus.

### BACKGROUND

In a known parking brake apparatus, a driver conducts a parking brake operation by means of a parking brake lever, a parking brake pedal or the like. Then, a parking brake wire is pulled by an operating force generated when the parking brake operation is conducted (hereinafter referred to as a parking brake operating force). As a result of the tension of the parking brake wire, a second braking member (e.g. a brake pad or a brake lining) is pressed against a first braking member (e.g. a disk rotor or a drum), thereby stopping a vehicle to park.

For example, a person such as a woman, an aged person and the like having less physical strength may apply insufficient operating force of the parking brake and may fail to apply a braking force necessary for parking the vehicle. Hence, in a parking brake apparatus disclosed in, for example, JP1994-344895A, a parking operation assisting means for assisting the parking brake operation by a hydraulic pressure pressurized by a pressurizing means is provided at the parking brake apparatus in order to reduce the parking brake operating force necessary for parking the vehicle. The parking operation assisting means of JP1994-344895A actuates an equalizer so as to pull the parking brake wire by the hydraulic pressure pressurized by the pressurizing means in response to the parking brake operation in order to assist the parking brake operation.

A level of the braking force appliable for parking the vehicle differs depending on how to press the second braking member. The parking brake apparatus disclosed in JP1994-344895A presses the second braking member more than in a case where the second braking member is pressed only by the bracing brake operating force applied by the driver, because the parking brake operation assisting means assists the parking brake operating force. However, in order to achieve the advantages and effects of the paring brake apparatus disclosed in JP1994-344895A, an individual and separate hydraulic circuit for actuating the equalizer by the hydraulic pressure needs to be provided at the pang brake apparatus because the parking brake operation assisting leans is provided thereat, thereby complicating a structure of the parking brake apparatus.

The second braking member is pressed against the first braking member not only for parking the vehicle, but also when the driver conducts a service brake (i.e. depression of a brake pedal) while the vehicle is moving. For example, if the service brake is repeatedly operated while the vehicle is moving on a road having a declining surface and the like, a temperature of the second braking member increases because of frictional heat generated when pressing the second braking member against the first braking member. As a result, the second braking member volumetrically expands. Therefore, if the parking brake operation is operated after the service brake is repeatedly operated, the second braking member is pressed against the first braking member in a state where the second braking member is volumetrically expanded. Hence, the braking force may decrease because the second braking member contracts due to a decrease of the temperature of the second braking afterwards. As a result, for example, in a case where the vehicle is parked on the road having an include surface, the vehicle may be displaced because of the decrease of the braking force.

A need thus exists to provide a parking brake apparatus which is not susceptible to the drawback mentioned above.

### SUMMARY OF THE INVENTION

According to an aspect of the present invention, a parking brake apparatus includes a first braking member provided at a wheel and integrally rotated with the wheel, a second braking member provided at a vehicle body side for stopping a rotation of the wheel, a parking brake means for pressing the second braking member to the first braking member by an operating force of a parking brake operation, a pressurizing means for pressurizing a brake fluid independently of the parking brake operation, and a hydraulic pressure controlling means for preliminarily pressing the second braking member to the first braking member by a brake fluid pressure pressurized by the pressurizing means in a case when the second braking member is pressed to the first braking member by means of the parking brake means.

According to another aspect of the present invention, a parking brake apparatus includes a first braking member provided at a wheel and integrally rotated with the wheel, a second braking member provided at a vehicle body side for stopping a rotation of the wheel, a parking brake device for pressing the second braking member to the first braking member by an operating force of a parking brake operation, a pressurizing device for pressurizing a brake fluid independently of the parking brake operation, and a hydraulic pressure controlling device for preliminarily pressing the second braking member to the first braking member by a brake fluid pressure pressurized by the pressurizing device in a case when the second braking member is pressed to the first braking member by means of the parking brake device.

### BRIEF DESCRIPTION OF THE DRAWINGS

The foregoing and additional features and characteristics of the present invention will become more apparent from the following detailed description considered with the reference to the accompanying drawings, wherein:

FIG. 1 is a view schematically illustrating a parking brake apparatus;

FIG. 2 is a view illustrating a configuration of a hydraulic pressure brake means;

FIG. 3 is a cross-sectional view illustrating a second brake caliper;

FIG. 4 is a flowchart illustrating a process of preliminary pressing of a second braking member relative to a first braking member; and

FIG. 5 is a cross-sectional view illustrating a drum brake.

### DETAILED DESCRIPTION

Embodiments of a parking brake apparatus will be described below.

[Brief overview]

The parking brake apparatus of the embodiments related to the present invention prevents a decrease of the braking force while applying a sufficient braking force for surely parking a vehicle, with a simple structure. More specifically, the parking brake apparatus of the embodiments presses a second braking member relative to a first braking member by means of a parking brake means in a state where the second braking member is preliminarily compressed by a hydraulic pressure controlling means preliminarily pressing the second braking member relative to the first braking member when applying a braking force to a wheel for parking a vehicle, so that the sufficient braking force is applied to the wheel by sufficiently compressing the second braking member. The second braking member is preliminarily pressed relative to the first braking member by means of the brake fluid pressure at a predetermined timing during a period between when the parking brake operation is started and when the second braking member is mechanically pressed relative to the first braking member. Further, the brake fluid pressure is used for preliminarily pressing the second braking member relative to the first braking member. Hence, the parking brake apparatus of the embodiments utilizes the existing hydraulic circuit, thereby preventing a structure of the parking brake apparatus from becoming complicated. Furthermore, even if the second braking member is volumetrically expanded because of an increase of a temperature of the second braking member, the volumetric expansion is reduced by preliminarily pressing the second braking member relative to the first braking member. Accordingly, a decrease of the braking force, occuring in response to a contraction of the second braking member caused by a decrease of the temperature of the second braking member afterwards, is prevented.

[Schematic Structure of Parking Brake Apparatus]

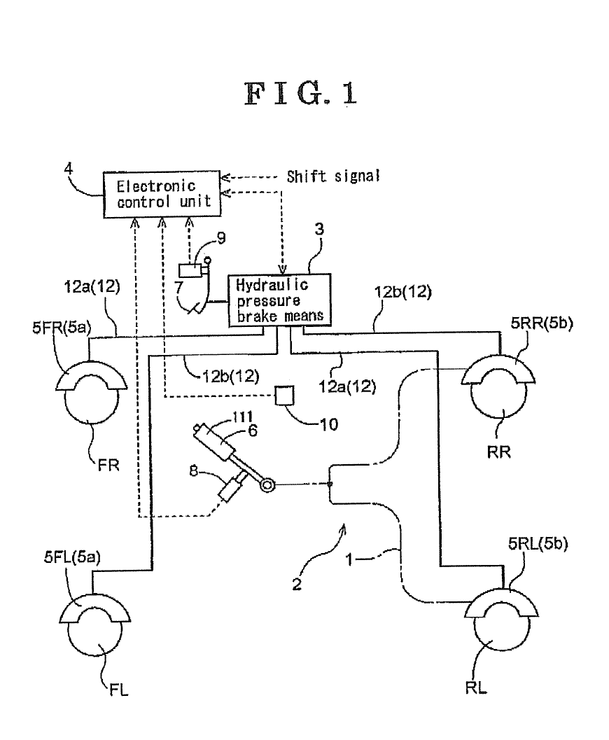

As illustrated in FIG. 1, the parking brake apparatus includes a parking brake means 2 (a parking brake device) for braking rear-wheels RR and RL by means of a parking brake wire 1, a hydraulic pressure brake means 3 (a hydraulic pressure brake device) for braking each of wheels FR, FL, RR and RL by means of a brake fluid pressure, and an electronic control unit 4 for controlling actuation and performance of the hydraulic pressure brake means 3. A first brake caliper 5a, which brakes a wheel by means of the brake fluid pressure, is provided at, for example, each of the front-wheels FR and FL. A second brake caliper 5b, which bakes a wheel by means of the brake fluid pressure and a tension of the parking brake wire 1, is provided at, for example, each of the rear-wheels RR and RL.

When a parking brake operation is conducted by a driver pulling a parking brake lever 6 (a parking brake operating means), the parking brake means 2 pulls the parking brake wire 1 by using an operating force of the parking brake and applies a tensile force to the second brake calipers 5b, thereby braking the rear-wheels RR and RL. On the other hand, when the driver conducts a service brake by depressing a brake pedal 7, the hydraulic pressure brake means 3 generates the brake fluid pressure in response to an operating force of the service brake and applies the brake fluid pressure to the first and second brake calipers 5a and 5b, thereby stopping the wheels FR, FL, RR and RL.

The parking brake lever 6 is provided with a parking brake switch 8 that serves as a parking brake operation detecting means for detecting the parking brake operation. The brake pedal 7 is provided with a stop lamp switch 9 for detecting the service brake operation A gravity sensor (i.e., G sensor) 10, serving as an inclination state detecting means, is provided at the vehicle for detecting an inclination state of a vehicle. A detection signal of each of the parking brake switch 8, the stop lamp switch 9 and the G sensor 10 is inputted to the electronic control unit 4.

[Hydraulic Pressure Brake Means]

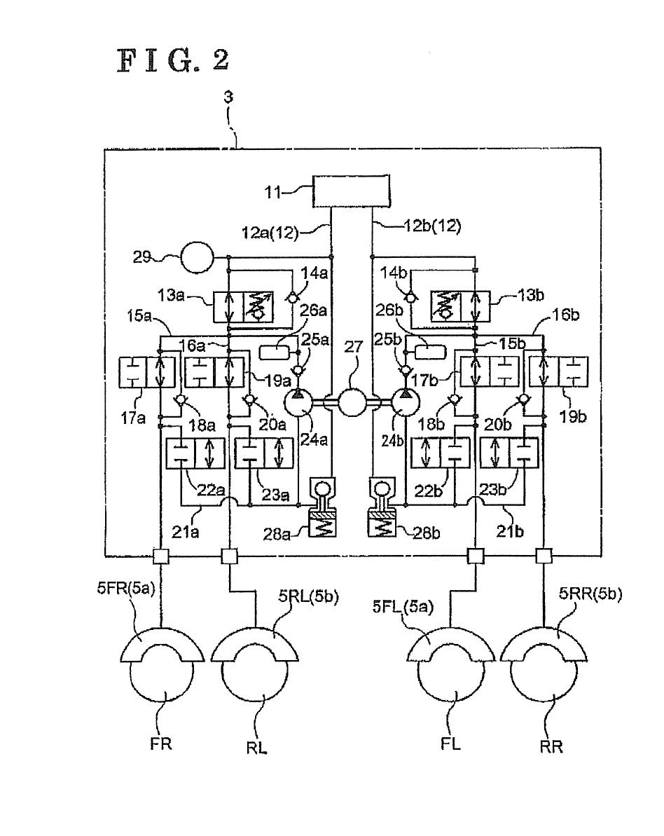

The hydraulic pressure brake means 3 will be described below with reference to FIG. 2. The hydraulic pressure brake means 3 includes a master cylinder 11 for generating a master cylinder hydraulic pressure in response to the operating force of the service brake, and a hydraulic circuit 12 for applying the master cylinder hydraulic pressure to each of the first brake caliper 5a, which is provided at each of the front-wheels FR and FL, and the second brake caliper 5b, which is provided at each of the rear-wheels RR and RL.

The master cylinder 11 is formed in a tandem-type cylinder having two hydraulic pressure chambers. The master cylinder 11 generates the master cylinder hydraulic pressure by a force generated by boosting the operating force of the service brake at a booster. Further, the master cylinder 11 is provided with a master reservoir for reserving surplus brake fluid therewithin and supplying a brake fluid to the master cylinder 11.

The hydraulic circuit 12 is formed with a first hydraulic circuit 12a for establishing fluid communication between one of the hydraulic pressure chambers of the master cylinder 11 and the brake caliper 5FR of the front-right wheel FR and the brake caliper 5RL of the rear-left wheel RL, and a second hydraulic circuit 12b for establishing the fluid communication between the other hydraulic pressure chamber of the master cylinder 11 and the brake caliper 5FL of the front-left wheel FL and the brake caliper 5RR of the rear-right wheel RR.

The first hydraulic circuit 12a is provided with a linear control valve 13a that changes a fluid communication state. A check valve 14a for the master cylinder 11 (hereinafter referred to as a master cylinder check valve 14a), which allows a flow of the brake fluid from the master cylinder 11 towards the brake caliper 5FR of the font-right wheel FR and he brake caliper 5RL of the rear-left wheel RL and prohibits the flow of the brake fluid from the brake calipers 5FR and 5RL towards the master cylinder 11, is provided at the first hydraulic circuit 12a so as to be arranged in parallel to the linear control valve 13a. The master cylinder check valve 14a is configured to allow the flow of the brake fluid from the master cylinder 11 towards the brake calipers 5FR and 5RL in order to apply the master cylinder hydraulic pressure to the brake calipers 5FR and 5RL, even if the linear control valve, 13a is in a fluid communication interrupting state. The fluid communicating state refers to a state where the flow of the brake fluid between the master cylinder 11 and, for example, each of the brake calipers 5FR and 5RL is established. The fluid communication interrupting state refers to a state where the flow of the brake fluid between the master cylinder 11 and, for example, each of the brake calipers 5FR and 5RL is interrupted.

The first fluid circuit 12a is diverged into a first branch hydraulic circuit 15a and a second branch hydraulic circuit 16a at a downstream side closer to the first and second brake, calipers 5FR and 5RL to the linear control valve 13a. The first branch hydraulic circuit 15a is connected to the brake caliper 5FR of the front-right wheel FR and the second branch hydraulic circuit 16a is connected to the brake caliper 5RL of the rear-left wheel RL. A first normally-open-control valve (NO valve) 17a, which is switchable into two positions (i.e. a fluid communicating position and a fluid communication interrupting position), is provided at the first branch hydraulic circuit 15a. The fluid communicating position refers to a position at which the flow of the brake fluid between the master cylinder 11 and, for example, the brake caliper 5FR of the front-right wheel FR is established. The fluid communication interrupting position refers to a position at which the flow of the brake fluid between the master cylinder 11 and, for example, the brake caliper 5FR of the front-right wheel FR is interrupted. A first check valve 18a, which allows the flow of the brake fluid from the brake caliper 5FR of the front-right wheel FR towards the master cylinder 11 and prohibits the flow of the brake fluid from the master cylinder 11 towards the brake caliper 5FR, is arranged in parallel to the first normally-open-control valve 17a. Similarly, the second branch hydraulic circuit 16a is provided with a second normally-open-control valve 19a corresponding to the first normally-open-control valve 17a, and a second check valve 20a corresponding to the first check valve 18a.

The first hydraulic circuit 12a includes a branch connecting circuit 21a that connects a fluid passage, diverged from the first branch hydraulic circuit 15a at the downstream side closer to the brake caliper 5PR relative to the first normally-open-control valve 17a, and a fluid passage diverged from the second branch hydraulic circuit 16a at the downstream side closer to the brake caliper 5RL relative to the second normally-open-control valve 19a. A first normally-closed-control valve (NC valve) 22a, which is switchable into two positions (i.e. the fluid communicating position and the fluid communication interrupting position), is provided at the fluid passage diverged from the first branch hydraulic circuit 15a in the branch communicating circuit 21a. Similarly, a second normally-closed-control valve 23a, which is switchable into two positions (i.e. the fluid communicating position and the fluid communication interrupting position), is provided at the fluid passage diverged from the second branch hydraulic circuit 16a in the branch connecting circuit 21a. The branch connecting circuit 21a further extends and connected at a point between the linear control valve 13a and the first and second normally-open-control valves 17a and 19a in the first hydraulic circuit 12a. A pump 24a, a third check valve 25a and a dumper 26a are provided at the branch connecting circuit 21a in this order towards upstream at a portion of the branch connecting circuit 21a extending from the point between the linear control valve 13a in the first hydraulic circuit 12a and the first and second normally-open-control valves 17a and 19a to a point where the flow of the brake fluid from the first branch hydraulic circuit 15a becomes confluent with the fluid of the brake fluid from the second branch hydraulic circuit 16a. More specifically, the pump 24a is provided closer to the brake calipers 5FR and 5RL at the branch connecting circuit 21a than the third check valve 25a and the damper 26a, the third check valve 25a is provided closer to the liner control valve 13a than the pump 24a, and the damper 26a is provided closest to the liner control valve 13a at the branch connecting circuit 21a. The pump 24a is configured to be rotatably driven by a motor 27 and to pressurize the brake fluid into a predetermined pressure and then discharge the pressurized brake fluid. A reservoir 28a is provided at the branch connecting circuit 21a between the first and second normally-closed-control valves 22a, 23a and the pump 24a. The reservoir 28a is connected hydraulically between the master cylinder 11 and the linear control valve 13a in the first hydraulic circuit 12a.

The first hydraulic circuit 12a in the hydraulic circuit 12 is described above. The second hydraulic circuit 12b is configured substantially the same as the first hydraulic circuit 12a, mid the second hydraulic circuit 12b is provided with the similar portions as the portions provided at the first hydraulic circuit 12a. More specifically, a liner control valve 13b, a first normally-open-control valve 17b, a second normally-open-control valve 19b, a first normally-closed-control valve 22b, a second normally-closed-control valve 23b, a pump 24b and the like are provided at the second hydraulic circuit 12b. A letter ‘a’ is added after an Arabic numeral indicating a portion provided at the first hydraulic circuit 12a, and a letter ‘b’ is added after an Arabic numeral indicating a portion provided at the second hydraulic circuit 12b, in order to indicate the identical portion. Hereinafter, in a case to indicate an identical portion provided at both of the first and the second hydraulic circuits 12a and 12b, the letters ‘a’ and ‘b’ after the Arabic numeral will be omitted.

The motor 27, according to the embodiment, includes a single motor which is configured to rotatably drive the pump 24a provided at the first hydraulic circuit 12a and the pump 24b provided at the second hydraulic circuit 12b. The pump 24, serving as a pressurizing means, is configured to pressurize the brake fluid independently of the parking brake operation. Alternatively, an accumulator may be provided at the hydraulic circuit 12 as the pressurizing means, instead of the pump 24. A hydraulic pressure sensor 29 for detecting the master cylinder hydraulic pressure is provided at the hydraulic circuit 12. In this embodiment, the hydraulic pressure sensor 29 is provided at the first hydraulic circuit 12a. However, the hydraulic pressure sensor 29 may be provided at the second hydraulic circuit 12b, instead of being provided at the first hydraulic circuit 12a. A detection signal of the hydraulic pressure sensor 29 is inputted to the electronic control unit 4.

The hydraulic pressure brake means 3 is configured so that the brake fluid pressure is independently appliable to each of the first and second brake calipers 5a and 5b (5FR, 5FL, 5RR and 5RL) by actuating each of the liner control valve 13, the first normally-open-control valve 17, the second normally-open-control valve 19, the first normally-closed-control valve 22, the second normally-closed-control valve 23 and the motor 27. In other words, the hydraulic pressure brake means 3 is configured so that the brake fluid pressure, pressurized by the pump 24, is independently appliable to each of the first and second brake calipers 5a and 5b (5FR, 5FL, 5RR and 5RL) without being influenced by the service brake operation. Further, the hydraulic pressure brake means 3 is configured so that the brake fluid pressure, pressurized by the pump 24, is appliable to the second brake calipers 5b (5RL and 5RR) independently of the parking brake operation.

[Structure of Brake Caliper]

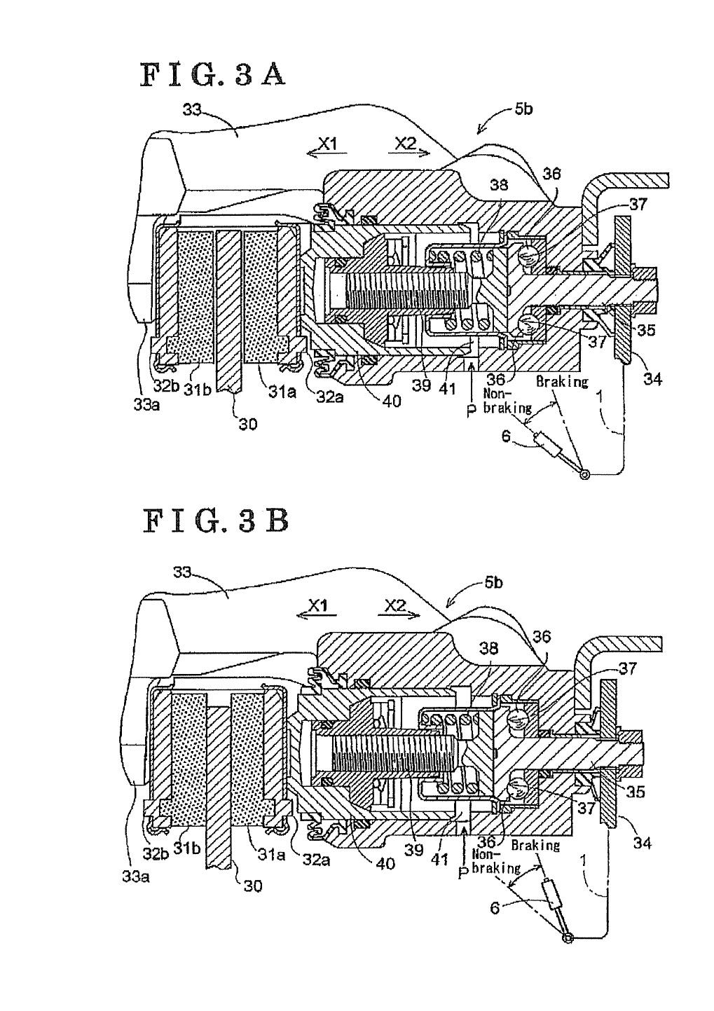

The first brake caliper 5a is provided at, for example, each of the front-right wheel FR and the front-left wheel FL, and is a brake caliper that presses a brake pad to a disk rotor by using the brake fluid pressure. The second brake caliper 5b is provided at, for example, each of the rear-right wheel RR and the rear-left wheel RL, and is a built-in caliper that presses the brake pad to the disk rotor by using the brake fluid pressure and/or the tension of the parking brake wire 1. The structure of the brake caliper will be described below with one of the second brake calipers 5b, which is the built-in caliper, as an example in accordance with FIG. 3. FIG. 3A illustrates a state where the second brake caliper 5b is not braking the wheel (i.e. a non-braking state). FIG. 3B illustrates a state where the second brake caliper 5b brakes the wheel (i.e. a braking state).

The second brake caliper 5b includes a disk rotor 30, which serves as a first braking member and integrally rotates with the wheel, and an inner pad 31a and an outer pad 31b, both of which serve as a second braking member The inner pad 31a and the outer pad 31b are provided so as to oppose to each other to the disk rotor 30. The wheel is braked by the inner pad 31a and the outer pad 31b being pressed on a first and second side surfaces of the disk rotor 30 facing the inner pad 31a and the outer pad 31b, respectively. A supporting member 33 of the second brake caliper 5b is supported at a mounting so as to be movable in an axial direction of the disk rotor 30. The inner pad 31a is supported at the supporting member 33 provided at a vehicle body side so as to be movable in the axial direction X1, X2 of the disk rotor 30 via a first back plate 32a. The outer pad 31b is supported by a claw portion 33a of the supporting member 33 via a second back plate 32b.

The second brake caliper 5b is configured to form a floating type brake caliper in which a piston 40 for operating the inner pad 31 is provided. The piston 40 is actuated in the direction of X1 in FIG. 3 from the non-braking state illustrated in FIG. 3A in order to press the inner pad 31a, so that the inner pad 31a is pressed on the first side surface of the disk rotor 30, as is shown in the braking state illustrated in FIG. 3B. Then, the supporting member 33 is moved in the direction of in FIG. 3 by using a reaction force generated by pressing the inner pad 31a on the first side surface of the disk rotor 30, so that the outer pad 31b is pressed on the second side surface of the disk rotor 30. As a result, the inner pad 31a and the outer pad 31b are pressed on the first and second side surfaces of the disk rotor 30, respectively. An elastic body 38 for biasing the piston 40 towards the direction of X2 in FIG. 3 is provided at the second brake caliper 5b, so that the piston 40 is biased to return to the non-braking state illustrated in FIG. 3A by a biasing force of the elastic body 38.

The second brake caliper 5b includes a crank lever 34, an input shaft 35, check balls 36 and an adjusting bolt 39 in order to mechanically press the inner pad 31a and the outer pad 31b to the disk rotor 30 by the parking brake operation. The crank lever 34 is rotatably actuated by the tension of the parking brake wire 1. The input shaft 35 is integrally rotated with the crank lever 34. The check balls 36 are engaged with engagement groove portions 37 formed at the input shaft 35, respectively. Each of the engagement groove portions 37 is formed so that a depth thereof becomes gradually and sequentially deeper towards a circumferential direction of the input shaft 35. The adjusting bolt 39 is provided within the piston 40 so that the adjusting bolt 39 is integrally movable with the piston 40 in the axial direction X1, X2 of the disk rotor 30.

When the parking brake wire 1 is pulled in response to the parking brake operation, the crank lever 34 is rotatably driven. Then, the input shaft 35 is rotated in a state where the check balls 36 are engaged with the corresponding engagement groove portions 37, in response to the rotational drive of the crank lever 34. A rotational movement is converted into a liner movement by the engagement between the check balls 36 and the engagement groove portions 37. As a result, an end portion of the input shaft 35 presses the adjusting bolt 39 towards the direction of X1 in FIG. 3, thereby integrally moving the adjusting bolt 39 and the piston 40 towards the direction of X1 in FIG. 3. Accordingly, the piston 40 presses the inner pad 31a. As a result the inner pad 31a and the outer pad 31b are pressed on the first and the second side surfaces of the disk rotor 30, respectively.

The piston 40 includes one end portion facing the inner pad 31a and the other end portion facing the input shaft 35. In order to press the inner pad 31a and the outer pad 31b against the disk rotor 30 by the hydraulic pressure generated by the hydraulic pressure brake means 3, a hydraulic pressure chamber 41, to which the brake fluid pressure from the hydraulic pressure brake means 3 is appliable, is formed behind the other end portion of the piston 40 in the axial direction thereof. By applying the brake fluid pressure generated by the hydraulic pressure brake means 3 to the hydraulic pressure chamber 41, the piston 40 is moved so as to press the inner pad 31a, thereby pressing the inner pad 31a and the outer pad 31b on the first and second side surfaces of the disk rotor 30, respectively.

[Application of Braking Force for Parking Vehicle]

When the parking brake operation is conducted by the driver, the parking brake means 2 pulls the parking brake wire 1 by the operating force of the parking brake and applies the tensile force to, for example, the second brake calipers 5b (e.g. 5RR and 5RL). Accordingly, the parking brake means 2 mechanically presses the inner pads 31a and the outer pads 31b to the disk rotors 30. A hydraulic pressure controlling means (a hydraulic pressure controlling device) is provided at the parking brake apparatus for preliminary pressing the inner pads 31a and the outer pads 31b to the disk rotors 30 by applying the brake fluid pressure, pressurized by the pump 24 (a preliminary application of braking force).

The hydraulic pressure controlling means corresponds to the hydraulic pressure brake means 3 and the electronic control unit 4. The electronic control unit 4 preliminarily presses the inner pads 31a and the outer pads 31b to the disk rotors 30 by controlling the operation and performance of the hydraulic pressure brake means 3. In other words, in order to preliminarily press the inner pads 31a and the outer pads 31b to the disk rotors 30, the electronic control unit 4 controls the hydraulic pressure brake means 3 so as to actuate the motor 27 and so as to apply the brake fluid pressure, pressurized by the pump 24, to the brake calipers 5RR and 5RL by controlling the liner control valve 13 and the first normally-open-control valve 17 to be in the interrupting state.

A compressing force is applied to the inner pads 31a and the outer pads 31b by the pressing force generated by preliminarily pressing the inner pads 31a and the outer pads 31b against the disk rotors 30. Accordingly, the inner pads 31a and the outer pads 31b are mechanically pressed to the disk rotors 30 by the parking brake operation in a state where the inner pads 31a and the outer pads 31b are preliminarily compressed. Hence, the inner pads 31a and the outer pads 31b are sufficiently compressed, and the sufficient braking force for surely parking the vehicle is appliable to the rear-wheels RR and RL by the parking brake operation with less operating force.

Additionally, by preliminarily pressing the inner pads 31a and the outer pads 31b to the disk rotors 30, the necessary operating force for mechanically pressing the inner pads 31a and the outer pads 31b to the disk rotors 30 in the packing brake operation is reduced. Therefore, the driver may not operate the parking brake lever 6 to an appropriate position because of the reduction of the operating force necessary for parking. Hence, for example, a sliding resistance member for applying a sliding resistance relative to the parking brake wire 1 may be provided at the parking brake apparatus, so that a predetermined resistance is applied relative to the operation of the parking brake lever 6. In this case, by modifying the parking brake apparatus so as to apply resistance by the sliding resistance member before the parking brake lever 6 reaches the appropriate position, the driver may notice whether or not the parking brake lever 6 is operated to the appropriate position, thereby appropriately actuating the parking brake apparatus.

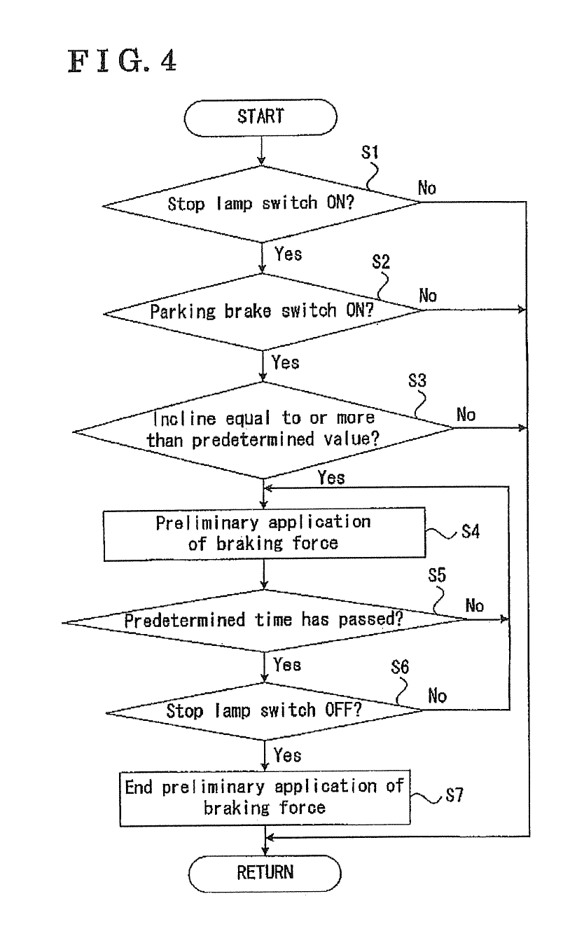

The preliminary pressing of the inner pads 31a and the outer pads 31b to the disk rotors 30 will be described below on tie basis of a flowchart illustrated in FIG. 4. The electronic control unit 4 outputs an operation signal and executes the preliminary pressing of the inner pads 31a and the outer pads 31b to the disk rotors 30 by using the brake fluid pressure in a case where the stop lamp switch 9 is ON, the parking brake switch 8 is ON and an inclination of the vehicle, detected by the G sensor 10, is equal to or greater than a predetermined value (e.g. a value greater than zero (0) degree of inclination angle) (S1, S2, S3, S4). In order to preliminarily press the inner pads 31a and the outer pads 31b to the disk rotors 30, the electronic control unit 4 controls the actuation of the motor 27 so as to pressurize the brake fluid pressure by means of the pump 24 for a difference between a target brake fluid pressure necessary for parking the vehicle and a present brake fluid pressure detected by the hydraulic pressure sensor 29. The target brake fluid pressure necessary for surely parking the vehicle so as not to be displaced even if the vehicle is parked on the inclined road surface is calculated in step S3 in the case where the inclination of the vehicle is equal to or greater than the predetermined value.

As the inner pads 31a and the outer pads 31b are preliminarily pressed to the disk rotors 30 when the parking brake operation is conducted by the driver and the parking brake switch 8 is turned on, the inner pads 31a and the outer pads 31b are preliminarily pressed to the disk rotors 30 by using the brake fluid pressure before the inner pads 31a and the outer pads 31b are mechanically pressed to the disk rotors 30 by the tension of the parking brake wire 1. More specifically, the inner pad 31a and the outer pad 31b are preliminarily pressed against the disk rotor 30 at a predetermined timing do a period between when the parking brake operation is started and when the inner pad 31a and the outer pad 31b are mechanically pressed against the disk rotor 30 by the parking brake operation. Accordingly, the inner pads 31a and the outer pads 31b are preliminarily pressed to the disk rotors 30 at an appropriate timing for preliminarily compressing the inner pads 31a and the outer pads 31b. In a case where the vehicle is parked at the road surface having an inclination equal to or greater than a predetermined value, relatively great braking force is needed for parking the vehicle. On the other hand, in a case where the vehicle is parked on a flat road having little inclination, relatively great braking force may not be needed. Therefore, in the parking brake apparatus of the above-described embodiment, the inner pads 31a and the outer pads 31b are preliminarily pressed against the disk rotors 30 in the case where the inclination of the vehicle is equal to or greater than the predetermined value, so that the vehicle is surely parked by applying relatively great braking force to the wheels, while preventing the inner pads 31a and the outer pads 31b from being preliminarily pressed against the disk rotors 30 in a case where the inclination of the vehicle is less than the predetermined value. Further, even if the inner pads 31a and the outer pads 31b are volumetrically expanded because of an increase of temperature thereof, the volumetric expansions of the inner pads 31a and the outer pads 31b are reduced by preliminarily pressing the inner pads 31a and the outer pads 31b against the disk rotors 30. As a result, the decrease of the braking force occurring due to contraction of the inner pads 31a and the outer pads 31b is prevented, thereby preventing the vehicle from being displaced.

The electronic control unit 4 ends the preliminary pressing of the inner pads 31a and the outer pads 31b to the disk rotors 30 in a case where a predetermined time (e.g. a few seconds) has passed after the electronic control unit 4 starts preliminarily pressing the inner pads 31a and the outer pads 31b to the disk rotors 30 and the stop lamp switch 9 is turned off (S5, S6 and S7). After the predetermined time (e.g. a few seconds) has passed since the electronic control unit 4 started pressing the inner pads 31a and the outer pads 31b to the disk rotors 30, the electronic control unit 4 determines that the parking brake operation has ended. Further, in a case where the driver ends the service brake while the sufficient braking force for parking the vehicle is not applied, the vehicle may unintentionally move. Hence, in the parking brake apparatus described above, in a case where the parking brake operation ends, the stop lamp switch 9 is turned off and the service brake operation is ended, the electronic control unit 4 determines that the vehicle is in a state where the sufficient braking force is applied to each of the rear-wheels RR and RL and ends the preliminary pressing of the inner pads 31a and the outer pads 31b to the disk rotors 30.

### Other Embodiments

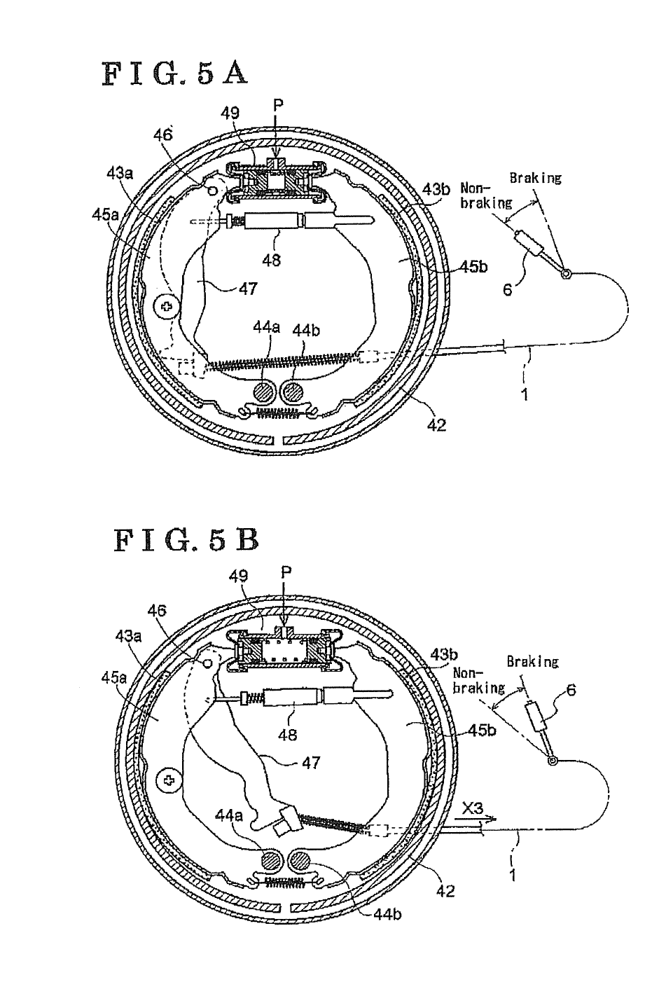

In the above-described embodiment, the second caliper 5b is provided at each of the rear-wheels RR and RL, and the each of the wheels FR, FL, RR and RL is braked by means of the corresponding disk brake. A case where the above-described parking brake apparatus is adapted to a vehicle having drum brakes will be described below in accordance with FIG. 5. FIG. 5A illustrates a state where the wheel is not braked by the corresponding drum brake (i.e. a non-braking state) and FIG. 5B illustrates a state where the wheel is braked (i.e. a braking state).

Each of the drum brakes includes a drum 42, which integrally rotates with the corresponding wheel and serves as the first braking member, and a first and second linings 43a and 43b serving as the second braking member. Hereinafter, the structure and functions of the drum brakes will be described with using one of the drum brakes as an example. The first lining 43a is supported by a first brake shoe 45a, which is pivotable around a first pivot pin 44a as a fulcrum. Similarly, the second lining 43b is supported by a second brake shoe 45b, which is pivotable around a second pivot pin 44b as a fulcrum. The first and second brake shoes 45a and 45b are pivoted so as to be away from each other from the positions in the non-braking state illustrated in FIG. 5A. As s result, as illustrated in FIG. 5B, the first and second linings 34a and 34b are pressed on an inner surface of the drum 42, thereby braking the wheel. An elastic body for biasing the first and second brake shoes 45a and 45b towards a direction by which the first and second brake shoes 45a and 45b approach each other is provided at the brake drum. The first and second brake shoes 45a and 45b are biased to return to the position in the non-braking state illustrated in FIG. 5A by a biasing force of the elastic body.

The drum brake includes a lever 47, which is pivotable around a third pivot pin 46 as a fulcrum, and a strut 48 for connecting the lever 47 and the second brake shoe 45, in order to press the first and second linings 43a and 43b against the drum 42 in the parking brake operation. When the parking brake wire 1 is pulled in a direction of X3 in FIG. 5B by the parking brake operation, the lever 47 pivots around the third pivot pin 46 as the fulcrum. Then, the first brake shoe 45a pivots around the first pivot pin 44a as the fulcrum towards a direction by which the first brake shoe 43a approaches the drum 42, thereby pressing the first lining 43a on the inner surface of the drum 42. Further, the second brake shoe 45b pivots around the second pivot pin 44b as the fulcrum by means of the strut 48 towards the direction by which the second brake shoe 45b approaches the drum 42, thereby pressing the second lining 43b on the inner surface of the drum 42. Further, the first brake shoe 45a and the second brake shoe 45b are connected to each other via a wheel cylinder 49 at one end portions of the first and second brake shoes 45a and 45b. The wheel cylinder 49 is configured so that the brake fluid pressure from the hydraulic pressure brake means 3 is appliable to the wheel cylinder 49, as indicated with an arrow P in FIG. 5. Accordingly, in a case where the brake fluid pressure from the hydraulic pressure brake means 3 is applied to the wheel cylinder 49, the first and the second brake shoes 45a and 45b pivot around the corresponding first and second pivot pins 44a and 44b, respectively, towards the opposite direction from each other so that the first and second brake shoes 45a and 45b move away from each other, thereby, pressing the first and second linings 43a and 43b on the inner surface of the drum 42.

In the above-described embodiments, detecting the parking brake operation by the parking brake switch 8 being turned on is disclosed as a condition for preliminarily pressing the inner pads 31a and the outer pads 31b to the disk rotors 30, however, other conditions may be employed. For example, a sensor member, such as a pressure-sensitive sensor 111 and the like, for detecting whether or not the driver touches the parking brake lever 6 may be provided at the parking brake lever 6, and a contact of the driver with a parking brake operating means, such as the parking lever 6 and the like, may be set as the condition. Still further, in a case where the parking brake apparatus of the embodiments is adapted to a vehicle having an automatic transmission, an input of a shift signal and an operation of a shift lever being shifted to a P-range may be set as the condition.

In the above-described embodiment, the electronic control unit 4 preliminarily presses the inner pads 31a and the outer pads 31b to the disk rotors 30 by using the brake fluid pressure in the case where the inclination of the vehicle is equal to or greater than the predetermined value. However, the parking brake apparatus of the embodiments may be modified so as to preliminarily press the inner pads 31a and the outer pads 31b to the disk rotors 30 without being influenced by the inclination of the vehicle. Further, a selection switch for selecting whether or not to preliminarily press the inner pads 31a and the outer pads 31b to the disk rotors 30 may be provided at a vehicle interior (e.g. in vicinity of a driver seat) so that the driver may select whether or not to execute the preliminary pressing of the inner pads 31a and the outer pads 31b to the disk rotors 30.

In the above-described embodiments, the stop lamp switch 9 being turned of after the predetermined time (e.g. a few seconds) has passed since the electronic control unit 4 starts preliminarily pressing the inner pads 31a and the outer pads 31b against the disk rotors 30 is set as an example of the condition for ending the preliminary pressing of the inner pads 31a and the outer pads 31b against the disk rotors 30, however, other conditions may be employed. For example, the stop lamp switch 9 being turned off may be set as the condition for ending the preliminary pressing of the inner pads 31a and the outer pads 31b against the disk rotors 30, regardless of whether or not the predetermined time (e.g. a few seconds) has passed after the electronic control unit 4 starts preliminary pressing the inner pads 31a and the outer pads 31b to the disk rotors 30.

In the above-described embodiments, the electronic control unit 4 determines that the parking brake operation has ended in the case where the predetermined time (e.g. a few seconds) has passed after the electronic control unit 4 starts preliminary pressing the inner pads 31a and the outer pads 31b to the disk rotors 30 by using the brake fluid pressure. However, the electronic control unit 4 may detect the end of the parking brake operation by providing a switch, which is turned on when the parking brake lever 6 is pulled up to an operation ending position, at the parking brake apparatus.

In the above-described embodiments, the parking brake lever 6, which actuates the parking brake by the driver upwardly pulling the same, is disclosed as the parking brake operating means for conducting the parking brake operation. However, a foot-operated parking brake, which is actuated by the driver depressing the same, may be adapted as the parking brake operating means.

The hydraulic circuit 12 may be modified so as to apply the brake fluid pressure to the first brake calipers 5a provided at each of the front-wheels FR and FL by way of the first hydraulic circuit 12a and to the second brake calipers 5b provided at each of the rear-wheels RR and RL by way of the second hydraulic circuit 12b. In other words, the configuration of the hydraulic circuit 12 is appropriately modified so that the brake fluid pressure is applied to each of the first and second brake calipers 5a and 5b through any desired circuits.

According to the embodiments, the parking brake apparatus is adaptable to any types of parking brake apparatus having the parking brake means for mechanically pressing the second braking member (31a, 31b/43a, 43b) to the first braking member (30/42) by the parking brake operating force. Accordingly, the parking brake apparatus of the embodiments prevents decrease of the braking force while applying a sufficient braking force for parking the vehicle to the wheels (i.e. the rear-wheels RR and RL) to which the parking brake apparatus is adapted.

Accordingly, the rotations of the disk rotors 30 (the drums 42) are stopped by the inner pads 31a and the outer pads 31b (the first linings 43a and the second linings 43b), therefore, the rotations of the wheels that integrally rotate with the corresponding disk rotors 30 (the drums 42) are stopped. More specifically, the parking brake apparatus is configured so that the compressing force is applied to the inner pads 31a and the outer pads 31b (the first linings 43a and the second linings 43b) by using the brake fluid pressure, pressurized by the pump 24, by the electronic control unit 4 preliminarily pressing the inner pads 31a and the outer pads 31b (the first linings 43a and the second linings 43b) against the disk rotors 30 (the drums 42) by means of the hydraulic pressure brake means 3, when the braking force for parking the vehicle is applied to the rear-wheels RR and RL. Hence, the inner pads 31a and the outer pads 31b (the first linings 43a and the second linings 43b) are pressed against the disk rotors 30 (the drums 42) in the state where the inner pads 31a and the outer pads 31b (the first linings 43a and the second linings 43b) are preliminarily compressed, thereby applying the sufficient braking force for surely parking the vehicle by sufficiently compressing the inner pads 31a and the outer pads 31b (the first linings 43a and the second linings 43b). Further, the inner pads 31a and the outer pads 31b (the first linings 43a and the second linings 43b) are preliminarily pressed against the disk rotors 30 (the drums 42) by using the brake fluid pressure. Therefore, the existing hydraulic brake circuit is utilized, thereby simplifying the structure of the parking brake apparatus. Still further, even if the inner pads 31a and the outer pads 31b (the first linings 43a and the second linings 43b) are volumetrically expanded because of the increase of the temperature thereof when the parking brake operation is conducted, the volumetric expansions of the inner pads 31a and the outer pads 31b (the first linings 43a and the second linings 43b) are reduced by preliminarily pressing the inner pads 31a and the outer pads 31b (the first linings 43a and the second linings 43b) against the disk rotors 30 (the drums 42). As a result, even if the temperature of the inner pads 31a and the outer pads 31b (the first linings 43a and the second linings 43b) decreases afterwards, the decrease of the braking force caused due to the contractions of the inner pads 31a and the outer pads 31b (the first linings 43a and the second linings 43b) may be prevented. Accordingly, the parking brake apparatus of the embodiments enhances a parking brake performance while enhancing the braking force for parking and preventing the decrease of the braking force.

According to the embodiments, the parking brake apparatus includes the parking brake operation detecting means for detecting the parking brake operation and outputting a detection signal to the hydraulic pressure controlling means (3, 4). Further, the electronic control unit 4 outputs an operation signal and preliminary presses the inner pads 31a and the outer pads 31b (the first linings 43a and the second linings 43b) to the disk rotors 30 (the drums 42) by means of the hydraulic pressure brake means 3.

Accordingly, in the parking brake apparatus of the embodiments, the electronic control unit 4 preliminarily presses the inner pads 31a and the outer pads 31b (the first linings 43a and the second linings 43b) against the disk rotors 30 (the drums 42) by means of the hydraulic pressure brake means 3 in the case where the parking brake switch 8 detects the paring brake operation and the electronic control unit 4 outputs the operation signal. Hence, in the case where the parking brake operation is conducted by the driver, the inner pads 31a and the outer pads 31b (the first linings 43a and the second linings 43b) are preliminarily pressed to the disk rotors 30 (the drums 42) by using the brake fluid pressure before the inner pads 31a and the outer pads 31b (the first linings 43a and the second linings 43b) are mechanically pressed to the disk rotors 30 (the drums 42) by the tensile force of the parking brake wire 1. More specifically, the inner pads 31a and the outer pads 31b (the first linings 43a and the second linings 43b) are preliminarily pressed against the disk rotors 30 (the drums 42) at the predetermined timing during the period between the parking brake operation is started by the driver and when the inner pads 31a and the outer pads 31b (the first linings 43a and the second linings 43b) are mechanically pressed against the disk rotors 30 (the drums 42) by means of the parking brake wire 1.

According to the embodiments, the parking brake operation detecting means includes the parking brake switch 8 that detects the parking brake operation conducted by the driver.

According to the embodiments, the parking brake operation detecting means includes the pressure-sensitive sensor 111 that is provided at the parking brake lever 6 and detects a contact of the driver with parking brake lever 6.

According to the embodiments, the parking brake apparatus includes the G sensor 10 for detecting the inclination state of the vehicle. Further, the electronic control unit 4 preliminarily presses the inner pads 31a and the outer pads 31b (the first linings 43a and the second linings 43b) to the disk rotors 30 (the drums 42) by using the brake fluid pressure by means of the hydraulic pressure brake means 3 in a case where the inclination G sensor 10 detects the inclination equal to or more than the predetermined value.

In the case where the inclination of the vehicle is equal to or greater than the predetermined value, relatively great braking force is needed for parking the vehicle. In this case, the parked vehicle may be displaced due to the decrease of the braking force caused by the contractions of the inner pads 31a and the outer pads 31b (the first linings 43a and the second linings 43b). Hence, in the parking brake apparatus of the embodiments, in the case where the G sensor 10 detects the inclination equal to or greater than the predetermined value, the electronic control unit 4 preliminarily presses the inner pads 31a and the outer pads 31b (the first linings 43a and the second linings 43b) against the disk rotors 30 (the drums 42) by means of the hydraulic pressure brake means 3 when the parking brake operation is conducted by the driver, so that relatively great braking force is applied to the rear-wheels RR and RL while preventing the decrease of the braking force. As a result, the parking brake apparatus of the embodiments is enhanced. More specifically, even in the case where the vehicle is parked on the road having the inclination equal to or greater to the predetermined value, the vehicle is prevented from being displaced.

According to the embodiments, the electronic control unit 4 ends the preliminary pressing of the inner pads 31a and the outer pads 31b (the first linings 43a and the second linings 43b) to the disk rotors 30 (the drums 42) in response to a completion of the service brake operation after the parking brake operation is ended.

After the driver completes the parking brake operation, the rear-wheels RR and RL are in the states where the braking force is applied thereto by the inner pads 31a and the outer pads 31b (the first linings 43a and the second linings 43b) being pressed relative to the disk rotors 30 (the drums 42). If the sufficient braking force is not applied to the rear-wheels RR and RL for parking the vehicle when the driver completes the parking brake operation, the vehicle may be moved. Therefore, the parking brake apparatus of the embodiments is configured so that the rear-wheels RR and RL are turned to be in the state where the sufficient braking force for parking the vehicle is applied thereto when the parking brake operation is completed and the service brake operation is ended. Further, the parking brake apparatus of the embodiments ends the preliminary pressing of the inner pads 31a and the outer pads 31b (the first linings 43a and the second linings 43b) relative to the disk rotors 30 (the drums 42) when the parking brake operation is completed and the driver releases the brake pedal. In other words, the parking brake apparatus of the embodiments ends the preliminary pressing of the inner pads 31a and the outer pads 31b (the first linings 43a and the second linings 43b) against the disk rotors 30 (the drums 42) at an appropriate timing.

According to the embodiments, the electronic control unit 4 preliminarily presses the inner pads 31a and the outer pads 31b (the first linings 43a and the second linings 43b) to the disk rotors 30 (the drums 42) by using the brake fluid pressure by means of the hydraulic pressure brake means 3 in a case where the shift lever of the automatic transmission provided at the vehicle is operated to be in the state indicating parking.

Accordingly, in the case where the parking brake operation is conducted by the driver, the inner pads 31a and the outer pads 31b (the first linings 43a and the second linings 43b) are preliminarily pressed to the disk rotors 30 (the drams 42) by using the brake fluid pressure before the inner pads 31a and the outer pads 31b (the first linings 43a and the second linings 43b) are mechanically pressed to the disk rotors 30 (the drums 42) by the tensile force of the parking brake wire 1. More specifically, the inner pads 31a and the outer pads 31b (the first linings 43a and the second linings 43b) are preliminarily pressed against the disk rotors 30 (the drums 42) at the predetermined timing during the period between the parking brake operation is started by the driver and when the inner pads 31a and the outer pads 31b (the first linings 43a and the second linings 43b) are mechanically pressed against the disk rotors 30 (the drums 42) by means of the parking brake wire 1.

According to the embodiments, the inner pads 31a and the outer pads 31b (the first linings 43a and the second linings 43b) are preliminarily pressed to the disk rotors 30 (the drums 42) at a predetermined timing during a period between when the parking brake operation is started and when the outer pads 31b (the first linings 43a and the second linings 43b) are preliminarily pressed to the disk, rotors 30 (the drums 42) by means of the parking brake means 2.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A parking brake apparatus comprising:
a first braking member provided at a wheel and integrally rotated with the wheel;
a second braking member provided at a vehicle body side for stopping a rotation of the first braking member;
a parking brake means for pressing the second braking member to the first braking member by an operating force of a parking brake operation;
a pressurizing means for pressurizing a brake fluid independently of the parking brake operation; and
a hydraulic pressure controlling means for preliminarily pressing the second braking member to the first braking member by a brake fluid pressure pressurized by the pressurizing means in a case when the second braking member is pressed to the first braking member by means of the parking brake means.

2. The parking brake apparatus according claim 1, further comprising a parking brake operation detecting means for detecting the parking brake operation and outputting a detection signal to the hydraulic pressure controlling means, wherein the hydraulic pressure controlling means outputs an operation signal and preliminary presses the second braking member to the first braking member.

3. The parking brake apparatus according to claim 2, wherein the parking brake operation detecting means includes a parking brake switch that detects the parking brake operation conducted by a driver.

4. The parking brake apparatus according to claim 2, wherein the parking brake operation detecting means includes a pressure-sensitive sensor that is provided at a parking brake operating means and detects a contact of a driver with the parking brake operating means.

5. The parking brake apparatus according to claim 1 further including an inclination state detecting means for detecting an inclination state of a vehicle, wherein the hydraulic pressure controlling means preliminarily presses the second braking member to the first braking member by using the brake fluid pressure in a case where the inclination state detecting means detects an inclination equal to or more than a predetermined value.

6. The parking brake apparatus according to claim 1, wherein the hydraulic pressure controlling means ends the preliminary pressing of the second braking member to the first braking member in response to a completion of a service brake operation after the parking brake operation is ended.

7. The parking brake apparatus according to claim 1, wherein the hydraulic pressure controlling means preliminarily presses the second braking member to the first braking member by using the brake fluid pressure in a case where a shift lever of an automatic transmission provided at the vehicle is operated to be in a state indicating parking.

8. The parking brake apparatus according to claim 1, wherein the parking brake means pulls a parking brake wire, provided at the parking brake apparatus, by the operating force of the parking brake and presses the second braking member relative to the second braking member provided at the wheel by a tensile force.

9. The parking brake apparatus according to claim 1, wherein the second braking member is preliminarily pressed to the first braking member at a predetermined timing during a period between when the parking brake operation is started and when the second braking member is pressed to the first braking member by means of the parking brake means.

10. A parking brake apparatus comprising:
a first braking member provided at a wheel and integrally rotated with the wheel;
a second braking member provided at a vehicle body side for stopping a rotation of the first braking member;
a parking brake device for pressing the second braking member to the first braking member by an operating force of a parking brake operation;
a pressurizing device for pressurizing a brake fluid independently of the parking brake operation; and
a hydraulic pressure controlling device for preliminarily pressing the second braking member to the first braking member by a brake fluid pressure pressurized by the pressurizing device in a case when the second braking member is pressed to the first braking member by means of the parking brake device.

11. The parking brake apparatus according claim 10, further comprising a parking brake operation detecting device for detecting the parking brake operation and outputting a detection signal to the hydraulic pressure controlling device, wherein the hydraulic pressure controlling device outputs an operation signal and preliminary presses the second braking member to the first braking member.

12. The parking brake apparatus according to claim 10, further including an inclination state detecting device for detecting an inclination state of a vehicle, wherein the hydraulic pressure controlling device preliminarily presses the second braking member to the first braking member by using the brake fluid pressure in a case where the inclination state detecting device detects an inclination equal to or more than a predetermined value.

13. The parking brake apparatus according to claim 10, wherein the hydraulic pressure controlling device ends the preliminary pressing of the second braking member to the first braking member in response to a completion of a service brake operation after the parking brake operation is ended.

14. The parking brake apparatus according to claim 10, wherein the second braking member is preliminarily pressed to the first braking member at a predetermined timing during a period between when the parking brake operation is started and when the second braking member is pressed to the first braking member by means of the parking brake device (2).
